(19) United States
(12) Patent Application Publication
(10) Pub. No.: US 2008/0179191 A1
(43) Pub. Date: Jul. 31, 2008

(54) TWO-STEP MOLECULAR SURFACE IMPRINTING METHOD FOR MAKING A SENSOR

(75) Inventors: Yanxiu Zhou, Phoenix, AZ (US); George N. Maracas, Phoenix, AZ (US)

Correspondence Address: INGRASSIA FISHER & LORENZ, P.C. (MOT), 7010 E. Cochise Road, SCOTTSDALE, AZ, 85253, US

(73) Assignee: MOTOROLA, INC., Schaumburg, IL (US)

(21) Appl. No.: 11/668,639

(22) Filed: Jan. 30, 2007

(51) Int. Cl. C25D 5/00; B05D 3/10

(52) U.S. Cl. 205/147; 427/337

(57) ABSTRACT

A method is provided for detecting target molecules (60) using a surface-molecularly imprinted sensor (52) and more particularly for detecting hydroxyl containing molecules, heavy metal ions, or thiol- or dialkylamine containing molecules by integrating molecular recognition and sensor transduction. The method includes soaking a support surface (14) in a solution containing a ligand molecule with headgroups that could adsorb on the surface of a substrate, or monomer to create a monolayer, a monolayer of polymerized organosiloxane groups (16), or a conducting film on the support surface (14). Template molecules (18) are then added to the imprinting solution so as to be positioned within the sparsely formed film, wherein the template molecules (18) comprise hydroxyl containing molecules, heavy metal ions, or thiol and dialkylamine containing molecules which prevents the interaction between monomer/ligand molecules and template molecules (18). In this case, there is a competitive reaction between the hydroxyl group on the surface of substrate and hydroxyl in ethanol molecule with monomer, e.g. OTS. The template molecules (18) are removed to define cavities in the imprinted film (16).

### FIELD OF THE INVENTION

The present invention generally relates to a method of chemical sensing and more particularly to detecting ionic activity of hydroxyl containing molecules by integrating molecular recognition and signal transduction.

### BACKGROUND OF THE INVENTION

Chemical sensors are used to detect chemical information, such as the presence of a specific molecule, and provide an alert to a user of the sensor when the presence is detected. Users of chemical sensors may include emergency response personal or industrial laborers, for example. Chemical sensors typically comprise a chemical recognition system and a physicochemical transducer. Molecular recognition, the selective binding of a molecule to a molecular receptor, can be used to fabricate a sensor system. Molecular recognition includes both chemical (non-covalent intermolecular) and physical (size and shape) recognition.

Molecularly imprinted polymers (MIPs) are man-made molecular recognition systems that mimic natural molecular recognition, such as antibody and antigen. MIPs are prepared by polymerization of functional monomers in the presence of a molecular template. The elution of the template results in cavities which are complementary in size, shape and chemical functionality with the template. These complementary cavities thus allow rebinding of target molecules with a high specificity, sometimes comparable to that of antibodies [Vlatakis, G.; Andersson, L. I.; Muller, R.; Mosbach, K., “Drug assay using antibody mimics made by molecular imprinting”, Nature 1993, v. 361, pgs. 645-647]. Surface imprinting is a new molecular imprinting technique that provides for cavities within an imprinted polymer on the surface of a transducer with no bonding between monomer and template molecules [“Surface imprinting—integration of recognition and transduction”, In Immunoassay and Other Bioanalytical Techniques, Zhou, Y., Yu, B., Levon, K. Ed: J. van Emon, CRC Press, Dec. 19, 2006]. U.S. Patent Publication 2004/0058380 describes this molecular surface imprinting technique wherein a polymer and template molecules are co-adsorbed onto a surface. There is no interaction between monomer and template molecule as in traditional MIPs. The template molecules are then removed to define cavities having a size and shape that selectively detects target molecules when exposed thereto (the target molecules being identical to the template molecules). However, this Patent Publication fails to provide a method for detecting hydroxyl containing molecules because hydroxyl containing molecules compete with the hydroxyl groups on the surface of a transducer and form a covalent bond with the monomer, e.g. octadecyltrichlorosilane (OTS), resulting in no polymer formed or molecular imprinted. The key principle of surface imprinting is no interaction between the monomer (such as OTS) and the template molecules (e.g. hydroxyl containing molecules, such as ethanol), or alkanethiols SAMs and metal ions (Hg²⁺, Cd²⁺, Pb²⁺ etc), or conducting polymer based surface imprinting technique, such as monomer pyrrole, aniline, with thiol, dialkylamine containing molecules (mercaptoethanol, mercaptoacetic acid, pyrrolidine, piperidine, morpholine).

Accordingly, it is desirable to provide a method for chemical sensing and more particularly for detecting of hydroxyl containing molecules, heavy metal ions, or thiol- or dialkylamine containing molecules by integrating molecular recognition and sensor transduction. Furthermore, other desirable features and characteristics of the present invention will become apparent from the subsequent detailed description of the invention and the appended claims, taken in conjunction with the accompanying drawings and this background of the invention.

### BRIEF SUMMARY OF THE INVENTION

A method is provided for chemical sensing and more particularly for detecting ionic activity by integrating molecular recognition and sensor transduction. The method comprises sparsely adsorbing monomers on a support surface, subsequently adsorbing template molecules on the support surface within the polymer, and removing the template molecules from the support surface.

### BRIEF DESCRIPTION OF THE DRAWINGS

The present invention will hereinafter be described in conjunction with the following drawing figures, wherein like numerals denote like elements, and

FIGS. 1-4 are partial schematic representations of the process in accordance with an exemplary embodiment;

FIG. 5 is a scheme depicting the assembly of a surface-molecularly imprinted sensor of FIG. 4 used with a potentiometer;

FIG. 6 is a schematic representation of the recognition mechanism of a surface-molecularly imprinted sensor to its target molecule;

FIG. 7 is a graph illustrating a comparison of potentiometric responses of ethanol on an ODS electrode with and without an ethanol template in accordance with the exemplary embodiment;

FIG. 8 is a graph showing optimization values for ethanol concentration in a deposition solution in accordance with the exemplary embodiment;

FIG. 9 is a graph showing optimization values for OTS monomer concentration in the deposition solution in accordance with the exemplary embodiment;

FIG. 10 is a graph showing the OTS coating time in accordance with the exemplary embodiment; and

FIG. 11 is a graph showing the insertion time for ethanol into the deposition solution during imprinting process in accordance with the exemplary embodiment;

FIG. 12 is a graph showing the effect of pH on ethanol sensor detection of ethanol in accordance with the exemplary embodiment; and

FIG. 13 is a graph illustrating the selectivity of an ethanol sensor to ethanol over other alcoholic molecules in accordance with the exemplary embodiment.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

The fabrication of surface-imprinted sensors for the detection of hydroxyl containing molecules, for example, water, ethanol (CH₃CH₂OH), methanol (CH₃OH), propanol (CH₃CH₂CH₂OH), butanol (CH₃CH₂CH₂CH₂—OH), isopropanol (OH—H₃C—CH₃), and a hydroxyl containing molecule comprises a two step process of coating a support surface with a polymer and template molecules. The preferred support surface comprises an indium-tin oxide (ITO)-coated glass electrode, but may comprise other surfaces including electrodes, optic fibers, polymer films, metal, alloys of metal, oxides, glassy carbon, graphite, metal foil, crystals, mica, silicon, semiconductors, quartz, glass, gold, platinum, and ceramics. The polymer may be absorbed on the support surface by soaking the support surface in a solution containing polymer monomers. The monomers which have headgroup ligand molecules in solution energetically arrange themselves to form a monolayer on the surface via molecular self-assembly processes, thus forming a self-assembled monolayer.

Hydroxyl containing template molecules are then absorbed on the support surface by adding the template molecules to the solution subsequent to the polymer being adsorbed on the support surface. The template molecules interact with the self-assembled molecules or monomers and position themselves near the support surface inside the film. A film or monolayer of polymers may be formed by electropolymerizing or simple adsorption. The specific template molecules absorbed is determined by the desired analyte (target molecules) to be detected by the sensor. Those template molecules may comprise one of water, alcoholic molecules, alcoholic vapors, hydroxyl containing compounds, and molecules that react with alkyltrichlorosilane. Alternately, target molecules that do not contain hydroxyl groups such as heavy metals including Hg²⁺, Cu²⁺, Pb²⁺, Cd²⁺ and those heavy metal ions that could form a complex with headgroup ligand molecules can be used.

The template molecules are then removed from the polymer film or monolayer to provide cavities for target molecules. The template molecules may be removed, for example, by solvent extraction, chemical cleavage, adding overpotential, hydrolytic cleavage, aging, thermal treatment, drying, conventional immersion extraction, ultrasonic-assisted extraction, microwave-assisted extraction, Soxhlet extraction, or neutral pH buffer. Since the template molecules are the same or similar in structure to the target molecules, the cavities are specific with regards to size, geometry (e.g., shape), and functionality for receiving (absorbing, detecting, sensing) the target molecules. This process provides stability (the polymer is covalently bound to the support surface), high selectivity (physical recognition of desired specificity target molecules to the exclusion of other molecules), higher sensitivity (close proximity to the support surface), and a simpler process (no interaction between the monomer and template molecules or functionalization of monomer or template).

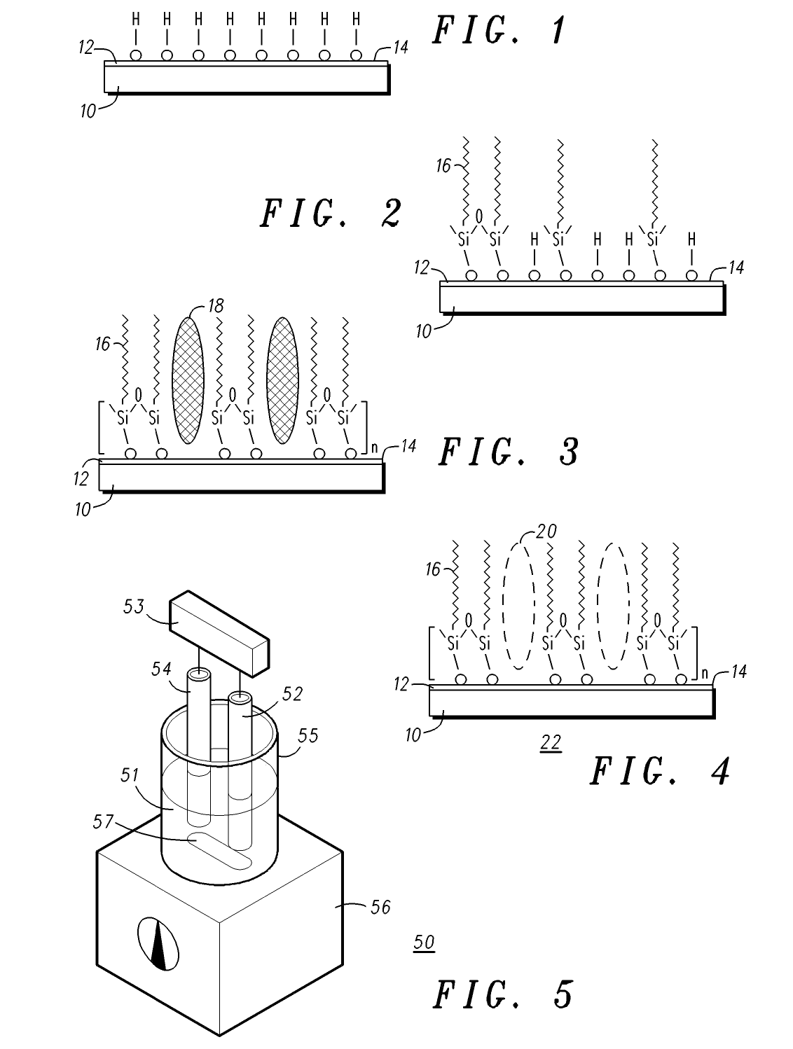

Referring to FIG. 1, an exemplary embodiment includes an indium-tin-oxide (ITO) layer 12 coated on a glass plate 10 and having a support surface 14 on which to fabricate a surface-molecularly imprinted sensor for hydroxyl containing target molecules (e.g., alcoholic molecules and their vapors, hydroxyl containing compounds, and molecules that react with one of alkyltrichlorosilane, alkylsiloxanes, and alkylsilanes), for example, water, methanol, ethanol propanol, butanol, or isopropanol. Ethanol will be described with the exemplary embodiment that follows. The ITO 12 coated glass plate 10 may be pretreated by a method described in “Organized monolayers by adsorption—formation and structure of oleophobic mixed monolayers on solid surfaces”, J. Sagiv, J. Am. Chem. Soc., 102, 92 (1980), resulting in hydroxyl group on the ITO layer 12. Soaking the substrate 14 in a solution of octadecyltrichlorosilane (OTS, C₁₈H₃₇SiCl₁₃ as a silylating agent), in CHCl₃/CCl₄ solution (2:3 v/v) at 0±10 Centigrade for a period of time causes the polymer to be sparsely absorbed on the ITO-coated glass surface 14, resulting in a hydrophobic monolayer of the polymerized organosiloxane groups 16 (ODS coating) to be formed (FIG. 2). As used herein, sparsely means a not fully formed film leaving gaps so the template molecules 18 may be inserted. Alternatively, a sparse film can be formed of monomers from the group consisting of aniline, pyrrole, thiophene, acetylene, and their derivatives.

The template molecules 18 comprising ethanol are then added to the solution of octadecyltrichlorosilane (OTS, C₁₈H₃₇SiCl₁₃ as a silylating agent) in CHCl₃/CCl₄ solution to position themselves within the ODS coating 16 and absorbed on the substrate surface 14 (FIG. 3). The monomer (OTS) re-organizes around the template molecule (such as ethanol), then assembles on the ITO glass, forming chemical bonding between the hydroxyl group on the ITO and OTS, and physical bonding between ethanol and surface oxide.

Once absorbed on the ITO-coated glass surface 14, the template molecules 18 are removed by rinsing the electrode with CHCl₃ to create cavities 20 (FIG. 4) within the ODS coating 16. The resulting sensor 22 may then be dried by allowing it to stand for a period of time at room temperature. Since OTS monolayers are stable in CHCl₃ and other solvents of low polarity, removing templates by repeated extractions with CHCl₃ creates the recognition cavities 20 in a stable network of polysiloxane film. The cavities 20 are specific with regards to size, geometry, and functionality as determined by the template molecules.

Surface molecular imprinting technology is combined with signal transduction and molecular recognition to detect molecules in solution. Surface imprinting technology gives sensors selectivity by creating a cavity with specific geometric features into which only molecules with complementary geometry (target molecules) may fit. Surface-molecularly imprinted sensors may be combined with an electrochemical detection system to generate an output signal associated with recognizing the target molecule.

FIG. 5 is an analytical instrument such as a potentiometric detection system 50, e.g., an Orion 920A potentiometer 53, that identifies specific analytes in a solution 51 by measuring the potential of reactions of interest. More specifically, FIG. 5 is a surface-molecularly imprinted sensor 52 coupled with a potentiometer 53. The surface-molecularly imprinted sensor 52 and a reference electrode 54 are immersed in the solution 51 containing target molecules. The electrodes 52 and 54 are coupled to the potentiometer 53 that measures the potential of reactions of interest occurring in the solution 51. The solution 51 is contained within a container 55 positioned optionally on a magnetic stirrer 56 which agitates the solution 51 with a stirring bar 57. The sensor 52 measures the potential difference in the solution with and without target molecules being present. The potentiometric detection system 50 may comprise one of an electrochemical, photometric, piezoelectric, surface acoustic wave, or thermal apparatus for detecting the presence of target molecules in the film.

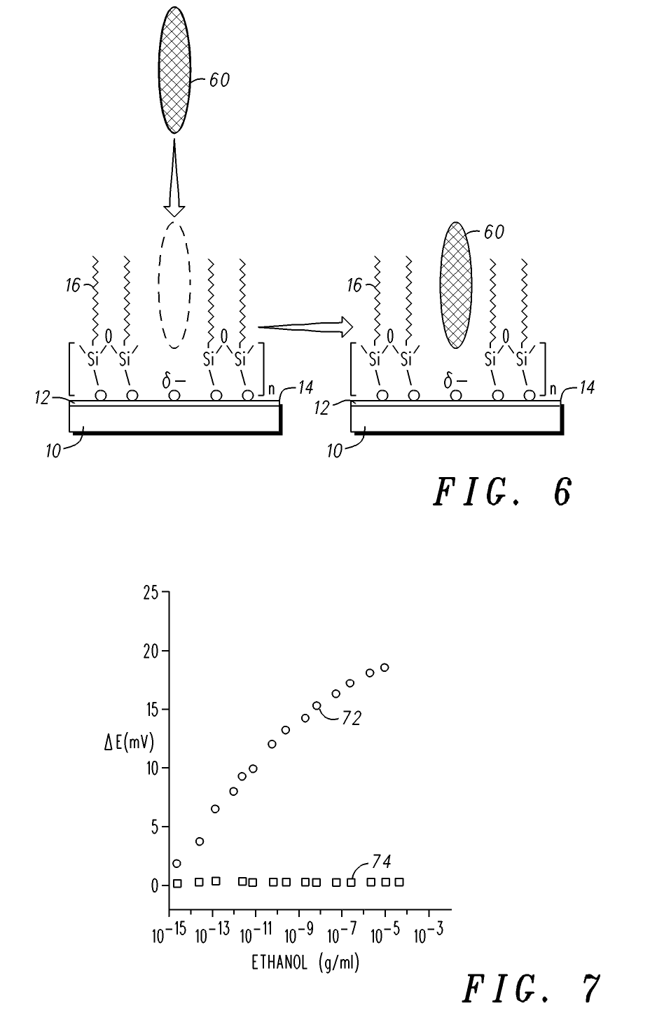

Referring to FIG. 6, the target molecules 60 are detected by hydrophobic interaction with the polymer monolayer 16 (physical recognition) and the electrostatic binding with the electrode surface 14 (chemical recognition). The hydrophobic interaction produces high selectivity since target molecules 60 with the same geometrical properties as the template molecules succeed in penetrating the polymer layer 16. The electrostatic interaction increases the chemical interaction energy between the target molecules 60 and the ITO electrode surface 14, thereby allowing the ITO electrode surface 14 to sense the recognition event because the electrostatic binding produces a measurable potential on the ITO electrode surface 14.

Though this process may be applied to the detection of any hydroxyl containing molecule, an optimization process for ethanol will be described as one exemplary embodiment. Four optimization steps will be discussed: ethanol concentration and OTS monomer concentration in the deposition solution, OTS coating time, and ethanol template molecule insertion time. Additionally, a method of optimizing the sensing condition by controlling the pH level will be discussed.

FIG. 7 is a graph showing the difference between surface 14 imprinting with and without ethanol template molecules. The results demonstrated that a surface 14 imprinted with ethanol 72 gave a greater potential change to ethanol molecules than that of without template molecules 74 during molecular imprinting (note that the latter gave almost no potential change). This confirms that ethanol molecules were incorporated into the adsorbed polysiloxane films, and extracted away, thereby forming the recognition sites.

Tests for the optimization of ethanol concentration and OTS concentration in the imprinting solution, OTS coating time, ethanol insertion time, and the effect of pH on detection of the target molecules were conducted. Referring to FIG. 8, the concentration of ethanol 82 is shown for a coating time of 2.5 minutes, an insertion time of 3.0 minutes, an OTS of 5×10⁻³ M at the deposition solution, in a PBS buffer of 0.10 M NaCl at a pH of 7.2 (solution 51 in FIG. 2). It is seen in that a higher potential difference is achieved by an ethanol concentration 82 in the range 84 of 15 to 40 micromoles in the deposition solution when [ethanol]=9.83×10⁻⁶ g/ml in the testing solution 51 in FIG. 5.

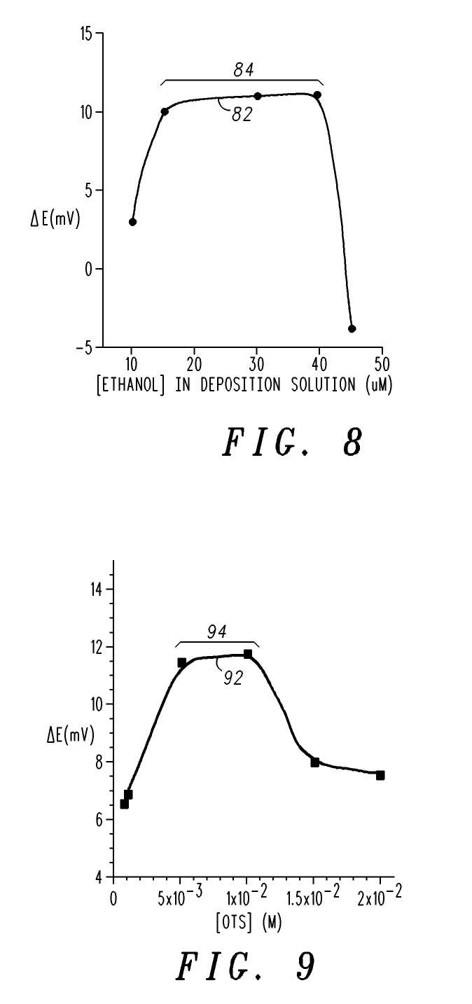

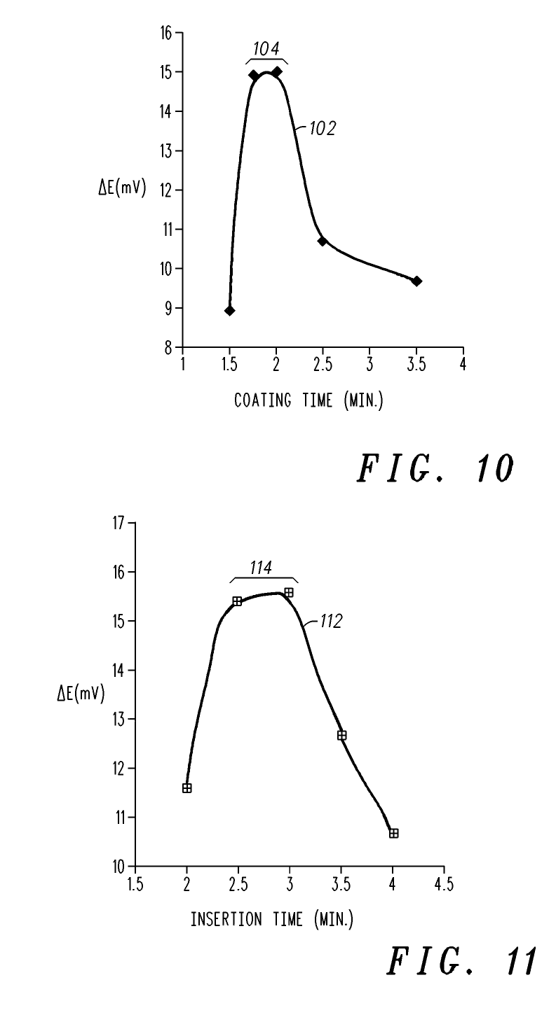

Referring to FIG. 9, the concentration of OTS 92 is shown for a coating time of 2.5 minutes, an insertion time of 3.0 minutes, and ethanol concentration of 34.2 mM at the deposition solution. This was measured in a PBS buffer of 0.10 M NaCl at a pH of 7.2. The highest potential difference is achieved by an OTS concentration 92 in the range 94 of 5×10⁻³ to 1×10⁻² moles, when [ethanol]=4.12×10⁻⁵ g/ml in the testing solution 51 in FIG. 5.

FIG. 10 shows the OTS coating time 102 for an insertion time of 3.0 minutes, with ethanol at 34.2 mM, OTS equaling 5×10⁻³ M at the deposition solution. This was measured in a PBS buffer of 0.10 M NaCl at a pH of 7.2. The highest potential difference 104 is achieved by an OTS coating time of 1.75 to 2.00 minutes, when [ethanol]=1.99×10⁻⁶ g/ml in the testing solution 51 in FIG. 5.

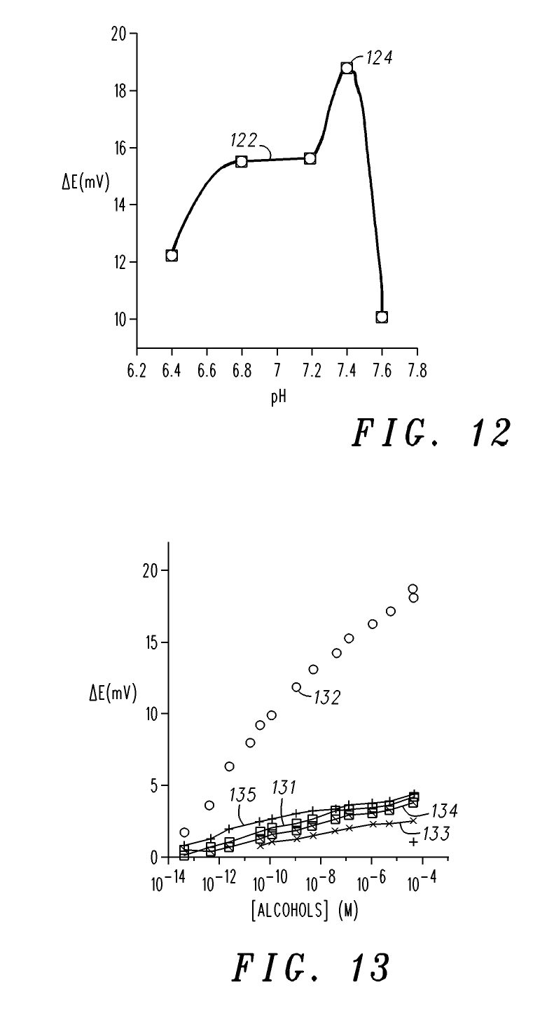

FIG. 11 shows the insertion time 112 of ethanol for a coating time of 2.0 minutes, with ethanol at 34.2 mM and OTS equaling 5×10⁻³ M at the deposition solution. This was measured in a PBS buffer of 0.10 M NaCl at a pH of 7.2. The highest potential difference 114 is achieved for the insertion time of ethanol in the range of 2.5 to 3.0 minutes, when [ethanol]=9.83×10⁻⁶ g/ml in the testing solution 51 in FIG. 5.

The effect of pH 122 on the detection of target molecules is illustrated in FIG. 12 for a coating time of 2.0 minutes, an insertion time of 3.0 minutes, with ethanol at 34.2 mM, and OTS equaling 5×10⁻³ M at the deposition solution. The highest potential difference 124 is achieved for a pH of approximately 7.4, when [ethanol]=9.83×10⁻⁶ g/ml in the testing solution 51 in FIG. 5.

Though this process may be applied to the detection of any hydroxyl containing molecule, tests for selectivity were conducted for methanol 131, ethanol 132, propanol 133, butanol 134, and isopropanol 135. The potential difference for each of these molecules is shown in the graph of FIG. 13. It is seen that the ethanol sensor provides the highest selectivity for detection of ethanol 132, achieving a potential difference approaching 18 millivolts, where the other alcoholic molecules achieve a potential difference in the range of 1.0 to 4.0 millivolts. Ethanol sensors made using this technology exhibit seven orders of magnitude lower limit of detection than conventional potentiometric sensors and demonstrated a very good selectivity to ethanol over other alcohols 131-135 compared to known methods.

A two step process for fabricating a surface-molecularly imprinted sensor includes coating a support surface first with a molecule templatable film comprise either a self-assembling molecules or conducting polymers in a solution and subsequently adding template molecules to the solution has been disclosed. Previously known processes, of co-adsorbing polymers and template molecules, for example, prevented the use of hydroxyl containing template molecules, such as ethanol. The selective and rapid detection of highly flammable ethanol and its vapor is of vital importance to public safety and the industry. This two step process provides ease of manufacture, high selectivity in detection, and ease of use.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road-map for implementing an exemplary embodiment of the invention, it being understood that various changes may be made in the function and arrangement of elements described in an exemplary embodiment without departing from the scope of the invention as set forth in the appended claims.

1. A method for fabricating a surface-molecularly imprinted sensor, the method comprising:
forming a molecule templatable film onto a support surface;
subsequently inserting template molecules onto the support surface and within the film; and
removing the template molecules from the film to create a plurality of cavities.

2. The method of claim 2 wherein the molecule templatable film comprises one of self-assembling molecules or conducting polymers.

3. The method of claim 1 further comprising a detection system comprising one of an electrochemical, photometric, piezoelectric, surface acoustic wave, or thermal apparatus for detecting the presence of target molecules in the film.

4. The method of claim 1 wherein the removing step comprises forming a plurality of cavities wherein each cavity comprises a shape and size substantially identical to one of the plurality of template molecules.

5. The method of claim 1 wherein the subsequently inserting step comprises inserting template molecules that interact with one of a plurality of monomers that form a conducting polymer or self-assembling molecules.

6. A method for fabricating a surface-molecularly imprinted sensor, the method comprising:
adsorbing ligand molecules with headgroups onto a support surface to form a self-assembled monolayer;
subsequently adsorbing template molecules onto the support surface and within the self-assembled monolayer; and
removing the template molecules from the self-assembled monolayer to create a plurality of cavities.

7. The method of claim 6 wherein the adsorbing ligand molecules onto a support surface step comprises adsorbing ligand molecules onto one of the materials selected from the group consisting of metal, alloys of metal, optic fibers, single crystals, disordered crystals, oxides, semiconductors, quartz, glass, glassy carbon, graphite, silicon, mica, polymer, or ceramics.

8. The method of claim 6 wherein the adsorbing step comprises adsorbing alkyltrichlorosilane, alkylsiloxanes, and alkylsilanes.

9. The method of claim 6 wherein the adsorbing step comprises adsorbing an organosulfur compound selected from the group consisting of alkanethiols (HS(CH₂)nX), dialkyl disulfides (X(CH₂)mS—S(CH₂)nX), and dialkyl sulfides (X(CH₂)mS(CH₂)nX), where n and m are the number of methylene units and X represents the end group of the alkyl chain (—CH₃, —OH, —COOH), ROH, RCOO—/RCOOH, RCOO OOCR, Ene-diol, RNH₂, RC≡N, R—N≡N⁺(BF₄⁻), RSAc, RSR′,

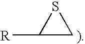

10. The method of claim 6 wherein the subsequently adsorbing step comprises selecting one from the group consisting of alcoholic molecules, alcoholic vapors, hydroxyl containing compounds, and molecules that react with alkyltrichlorosilane.

11. The method of claim 6 wherein the adsorbing step comprises creating a monolayer of a plurality of polymerized organosiloxane groups.

12. The method of claim 6 wherein the subsequently adsorbing step comprises adsorbing one target molecule selected from a group consisting of Hg²⁺, Cu²⁺, Pb²⁺, Cd²⁺ and those heavy metal ions that could form a complex with headgroup ligand molecules.

13. The method of claim 6 wherein the removing step is selected from the group consisting of solvent extraction, chemical cleavage, hydrolytic cleavage, aging, thermal treatment, drying, conventional immersion extraction, ultrasonic-assisted extraction, microwave-assisted extraction, Soxhlet extraction, and neutral pH buffer.

14. A method for making a surface-molecularly imprinted sensor, the method comprising:
immerse an electrode in a solution containing a plurality of monomers to electropolymerize and create a film of a plurality of conducting polymers on a surface of the electrode;
subsequently adding a plurality of template molecules to the solution to position the template molecules within the film; and
removing the template molecules to create a plurality of cavities in the film.

15. The method of claim 14 wherein the monomers comprises one selected from the group consisting of aniline, pyrrole, thiophene, acetylene, and their derivatives.

16. The method of claim 14 wherein the subsequently adding step comprises electropolymerizing the solution containing the plurality of monomers.

17. The method of claim 14 wherein the removing step is selected from the group consisting of solvent extraction, adding overpotential, chemical cleavage, hydrolytic cleavage, aging, thermal treatment, drying, conventional immersion extraction, ultrasonic-assisted extraction, microwave-assisted extraction, and Soxhlet extraction, or neutral pH buffer.
